(19) United States
(12) Patent Application Publication
(10) Pub. No.: US 2009/0160700 A1
(43) Pub. Date: Jun. 25, 2009

(54) Monitoring and Mapping of Atmospheric Phenomena

(76) Inventors: Hagit Messer-Yaron, Kfar Saba (IL); Pinhas Alpert, Moshav Gamliel (IL); Artem Zinevich, Tel Aviv (IL); Oren Goldshtein, Naharya (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 11/995,535

(22) PCT Filed: Jun. 29, 2006
(86) PCT No.: PCT/IL06/00756

§ 371 Date: Jan. 13, 2008

Related U.S. Application Data
(60) Provisional application No. 60/698,491, filed on Jul. 13, 2005.

(51) Int. Cl. G01S 13/95

(52) U.S. Cl. 342/26 R

(57) ABSTRACT

A computerized system for mapping an atmospheric phenomenon in a geographic region. Multiple free-space electromagnetic communications links are previously distributed in the geographic region. The system includes an interface to monitoring mechanisms attached respectively to the free-space electromagnetic communications links. The monitoring mechanisms respectively monitor attenuation levels of the free-space electromagnetic communications links. A processor simultaneously processes the attenuation levels, and maps in the geographic region the atmospheric phenomenon. The simultaneous processing preferably applies a non-linear model which relates the attenuation levels the atmospheric phenomenon, and solves a tomographic problem based on the non-linear model and the attenuation levels. The tomographic problem is preferably solved by an interactive algorithm based on consecutive refinement and linear inversion at each iteration. Alternatively, an interpolation is performed based on respective inverse distance from the communications links. Preferably, the interpolation is further based on respective lengths of communications links. A data interface preferably provides to subscribers temporal information related to the atmospheric phenomenon within portions of the geographic region.

### FIELD AND BACKGROUND OF THE INVENTION

The present invention relates to monitoring of atmospheric phenomena based on attenuation of radio links and, more particularly, to the estimation and mapping of rainfall rate using previously existing radio links distributed in a geographic area being monitored. Specifically, the method in some embodiments includes linearizing of a non-linear tomographic problem.

Accurate monitoring of atmospheric parameters is of great importance to many applications including weather forecasting, hydrology, flood warning, water planning and pollution regulation. Monitoring is performed using dedicated equipment such as weather radars, disdrometers, and/or rain gauges. Active microwave sensing of the atmosphere is currently used for atmospheric studies. Active microwave sensing involves scattering when the strength of a received signal is measured and ranging when time delay between transmitter and receiver is measured. Weather radars provide information about precipitation, typically rainfall rate and wind velocity based on backscattering reflectivity and Doppler effects, however dedicated weather radars are expensive and not widespread

Meteorological monitoring of rainfall by radar is not accurate enough at surface levels, especially on topographic slopes. It is well known that estimating rainfall on topographic slopes is highly problematic, but crucial for flood warnings. Topography clutter particularly at the lee side of the mountain interferes with radar and the positioning of rain gauges over slopes is also debated in the literature. Suggestions have been made to employ “Inclined Rain gauges” along with standard rain gauges.

Microwave sensing systems (e.g AMSU—Advanced Microwave Sounding Unit) operate on frequencies 20-200 GHz, where atmospheric absorption plays a major role to detect fog, clouds, and water vapor. The lack of data or observations with high spatial and temporal resolution is a major issue in atmospheric studies, especially in sparsely inhabited regions. Rain gauge networks are used in addition to weather radar for real time estimates of rainfall rate distribution. Rain gauges are accurate but are expensive to operate and do not provide sufficient spatial and temporal resolution. Rain gauges provide point measurements while for hydrological purposes such as forecasting risk events as well as for model verification, spatially distributed measurements are required.

A disdrometer is an instrument used to measure the drop size distribution and velocity of different types precipitation e.g. rain, snow and hail. Disdrometers are used for traffic control, scientific examination, airport observation systems, and hydrology. and employ microwave or laser technologies.

Wireless communication technologies have rapidly grown during the past decade. As an example, cellular base stations are commonly fed by backhaul point-to-point microwave links carrying E1/T1 telecommunications signals. Cellular operators typically monitor the received signal levels (RSL) or attenuation of the microwave links. The received signal levels are typically monitored by management networks. Another wireless technology on the rise is based on standard IEEE 802.16 (WIMAX) and includes point to point radio links for broadband access, typically in the frequency range 2.5-5 GHz. WIMAX technology is expected to provide infrastructure for local broadband access using fixed and mobile links over several kilometers.

The transmission loss for a radio link due to various atmospheric phenomena is illustrated in FIG. 1^{1,2}: excess attenuation due to water vapour, mist and fog, absorption losses due to oxygen and other gases, and scattering loss due to precipitations, primarily rainfall. Rainfall attenuation depends on the size and distribution of the water droplets. There are several empirical models which allow calculation of attenuation (dB/km) due to rainfall rate (mm/hour). One approach, is power law of attenuation A=aR^{b}, where R is a rainfall rate and the constants a and b are evaluated through a regression fit to frequency polarization, and temperature. Constants a and b have been evaluated for different links and are available (for instance see Power-Law Parameters of Rain Specific Attenuation, IEEE 802.16 cc-99/24, of National Institute of Standards and Technology) Another empirical model is provided by ITU recommendations, based on nominal droplets size and distribution and allows calculation of attenuation rate (dB/km) due to the specified rainfall rate. 1. International Telecommunication Union Recommendation ITU-R P. 838-3-321, 20032. Tomas L. Frey. The Effects of the Atmosphere and Weather on the performance of a mm-Wave Communication Link—Applied Microwave and Wireless, February 1999

In a paper entitled, “Tomographic Reconstruction of Rainfall Fields through Microwave Attenuation Measurements” (J. American Meteorological Society, September 1991, p. 1323) Giuli et al., presents a tomographic approach for monitoring rainfall using multiple attenuation measurements of microwave links in an area. Giuli et al. discuss different sources of errors involved in the use of power law empirical models of rainfall attenuation. One source of error arises from the fact that the power law itself is an approximation and assumes a specific droplet size and shape distribution, and further ignores other factors such as turbulence and local winds and local humidity. Another known source of error in the use of power-law empirical models is the variation in rainfall rate along the measurement path, i.e. along the link, since typically only the average rainfall may be estimated along the link. In order to mitigate these errors, Giuli et al. suggested calculating rainfall rate fields using a tomographic approach using attenuation of microwave links distributed throughout the monitored region, of single frequency ˜30-35 Ghz where the power law is approximately linear (b˜1).

Other researchers³ have demonstrated that, if two co-located microwave links are installed, two frequencies and/or polarization states could be selected for which the specific attenuation difference is relatively insensitive to the unknown parameters, e.g. droplet size and shape distribution. After the raw attenuation measurements have been adjusted for gaseous absorption, there is a linear relationship between the attenuation difference parameter and rainfall rate. In this way, the problem of solving the non-linear problem is avoided, however, dual-links need to be installed within the area. 3. Microwave Links—A Precipitation Measurement Method filling the Gap between Rain Gauge and Radar Data? in 6th INTERNATIONAL WORKSHOP on PRECIPITATION IN URBAN AREAS, Measured and Simulated Precipitation Data Requirements for Hydrological Modelling, 4-7 Dec., 2003, Pontresina, Switzerland (and references therein)

There is thus a need for, and it would be highly advantageous to have a method of mapping of atmospheric phenomena and particularly rainfall rate in an area using previously existing infrastructure distributed in the area, wherein the previously existing links are not constrained to be of a particular frequency nor require co-located dual frequency links.

The term “electromagnetic” as used herein in the context of electromagnetic free-space communications links refers to the part of the electromagnetic spectrum useful for free space communications between the optical portion including microwaves, millimeter waves through radio waves of wavelength on the order of meters. The term “radio” and “microwave” are used herein interchangeably as examples of electromagnetic links.

The term “mapping” as used herein in the context of “mapping” an atmospheric phenomena in a geographic region, refers to associating a quantity, e.g. rainfall rate to areas or cells within the geographic region.

The terms “rainfall rate” and “rainfall intensity” are used herein interchangeably.

The term “simultaneous processing” as used herein refers to processing of attenuation levels, received signal levels and/or statistical information based on the attenuation or received signals of multiple electromagnetic links simultaneously to estimate and map atmospheric phenomena. An advantage of “simultaneous processing” over processing link information individually is a significant reduction of overall errors.

### SUMMARY OF THE INVENTION

According to the present invention there is provided a method for mapping an atmospheric phenomenon in a geographic region. Multiple previously existing free-space electromagnetic communications links, e.g. cellular backhaul microwave links, are distributed in the region. Attenuation levels are monitored respectively by monitoring mechanisms attached to the free-space electromagnetic communications links. The attenuation levels are simultaneously processed for mapping the atmospheric phenomenon in the geographic region. The simultaneous processing preferably applies a non-linear model which relates the attenuation levels to the atmospheric phenomenon, and solves a tomographic problem based on the non-linear model and the attenuation levels. An iterative algorithm is preferably performed based on consecutive refinement and linear inversion at each iteration. Alternatively, an interpolation is performed based on respective inverse distance from the communications links. Preferably, the interpolation is further based on respective lengths of communications links. The geographic region is preferably subdivided into cells based on a spatial density of the links in cells; and the atmospheric phenomenon is calculated in the cells. The atmospheric phenomenon is one or more of precipitation (e.g. rain, sleet, snow, hail), fog, dust, pollutants and water vapor. When two or more independent atmospheric phenomena are considered, a blind signal separation technique is used, to separately map the independent atmospheric phenomena. Mapping is alternatively performed at a point in the region by applying a probabilistic model based on respective proximity of the links to the point.

According to the present invention there is provided a computerized system for mapping an atmospheric phenomenon in a geographic region. Multiple free-space electromagnetic communications links are previously distributed in the geographic region. The system includes an interface to monitoring mechanisms attached respectively to the free-space electromagnetic communications links. The monitoring mechanisms respectively monitor attenuation levels of the free-space electromagnetic communications links. A processor simultaneously processes the attenuation levels, and maps in the geographic region the atmospheric phenomenon. The simultaneous processing preferably applies a non-linear model which relates the attenuation levels to the atmospheric phenomenon, and solves a tomographic problem based on the non-linear model and the attenuation levels. An iterative algorithm is preferably performed based on consecutive refinement and linear inversion at each iteration. Alternatively, an interpolation is performed based on respective inverse distance from the communications links. Preferably, the interpolation is further based on respective lengths of communications links. Preferably, a previously existing management system is connected to the monitoring mechanisms, and transfers the received attenuation levels to the processor. A previously existing meteorological measurement device is preferably situated in the geographic region. A measurement of the previously existing meteorological measurement device is input to the processor for mapping the atmospheric phenomenon. The previously existing meteorological measurement device is preferably a rain gauge, a disdrometer and/or a weather radar. Preferably, at least two of the free-space electromagnetic communications links (not necessarily co-located) have a different operative parameter, such as wavelength and polarization. Preferably, one or more free-space electromagnetic communications links has diversity receivers, and multiple received diversity attenuation levels from the diversity receivers are input to the processor or multiple received diversity signals from diversity receivers are pre-processed based on the type of diversity. A data interface preferably provides to subscribers temporal information related to the atmospheric phenomenon within portions of the geographic region.

According to the present invention there is provided a program storage device readable by a computer. The computer is operatively attached to previously existing free-space electromagnetic communications links distributed in a geographic region. Attenuation levels are respectively monitored by monitoring mechanisms attached respectively to the links. The program storage device tangibly embodies a program of instructions executable by the computer to perform a method of simultaneously processing the attenuation levels, thereby mapping in the geographic region the atmospheric phenomenon. Preferably, the program of instructions includes applying a non-linear model relating the attenuation levels to the atmospheric phenomenon, and solving a tomographic problem based on the non-linear model and the attenuation levels. An iterative algorithm is performed based on consecutive refinement and linear inversion at each iteration. Alternatively, the program of instructions includes an interpolation based on respective inverse distance from the communications links. Preferably, the interpolation is further based on respective lengths of communications links.

### BRIEF DESCRIPTION OF THE DRAWINGS

The invention is herein described, by way of example only, with reference to the accompanying drawings, wherein:

FIG. 1 is a prior art graph of attenuation through the atmosphere of rain at different rainfall rates (mm/hour) and absorption peaks of gaseous species within the atmosphere;

FIG. 2 is a drawing illustrating locations of cellular backhaul links (dashed lines) and rain gauge stations around Haifa (left), Tel-Aviv and Jerusalem (right) used for proving feasibility of the present invention;

FIG. 3 a, b, c show time slices of dynamic rainfall rate maps, as generated according to the non-linear tomographic reconstruction model, according to an embodiment of the present invention and compared to weather radar images, in one of the regions of FIG. 2;

FIG. 4 shows graphs of rainfall rate, according to an embodiment of the present invention, as a time-series, where rainfall amount measurements provided by rain gauges, weather radar and cellular backhauls are compared;

FIG. 5 illustrates schematically the tomography problem for mapping of rainfall intensities in a geographic region, according to an embodiment of the present invention;

FIG. 6 is an illustration of a simulated rainfall at a point in time in a simulated geographic region;

FIG. 7 shows the reconstruction of rainfall intensity in the simulation;

FIG. 8 is an illustration of links in a geographic region and a method for converting the links into data points, according to an embodiment of the present invention;

FIG. 9 is a drawing of a computerized system, according to an embodiment of the present invention; and

FIG. 9b is a drawing of a prior art computer used for processing and mapping of atmospheric phenomena.

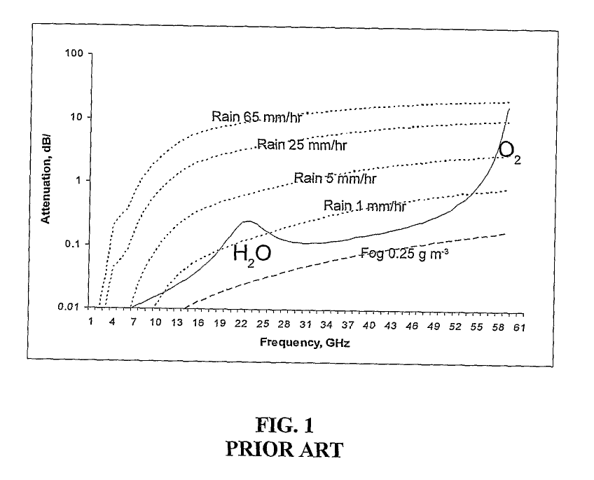

### DESCRIPTION OF THE PREFERRED EMBODIMENTS

The present invention is of a system and method for mapping atmospheric phenomena and particularly rainfall rate in a geographic area using previously existing radio infrastructure distributed in the area.

The principles and operation of a system and method of mapping atmospheric phenomena, e.g. rainfall intensity, in a geographic area using previously existing infrastructure distributed in the area, according to the present invention, may be better understood with reference to the drawings and the accompanying description.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

By way of introduction, a principal intention of the present invention is to provide information regarding atmospheric phenomena using information gathered from previously existing free-space electromagnetic point-to-point communications links. The information is typically in the form of a received signal level for each link, when the transmitted signal level is known, or attenuation levels typically in decibel units (dB) divided by the length of the communications link in kilometers (km). The atmospheric phenomena include precipitation, fog, air pollution and dust. Typically, the received signal level or attenuation in db/km is not generally a direct measure of the atmospheric phenomena of interest and further typically more than one atmospheric phenomenon influence the attenuation level either by absorption at the particular electromagnetic frequency in use or by scattering. Mathematical models either empirical or analytical are used which relate the atmospheric phenomena to measured attenuation levels. The models are typically non-linear and dependent on link parameters such as electromagnetic frequency and polarization and environmental parameters such as temperature and humidity. The attenuation levels and relevant models are used to formulate a non-linear tomographic problem which is solved iteratively with linear inversion at each iteration, probabilistic reconstruction and/or inverse distance interpolation, according to teachings of the present invention. When other data are available such as rainfall data or visibility data from a weather radar, the solution of the problem may be constrained or normalized based on the other data. Similarly, a priori known information and/or various prediction models may be used to generate or estimate parameters such as precipitation type, and drop size distribution in different geographic regions.

Another intention of the present invention is to provide a reliable method for measuring rainfall on slopes since according to embodiments of the present invention a line-integrated rainfall measurement is provided along previously existing electromagnetic links parallel to the slope of the terrain.

In many free-space communications links, multiple links are installed to improve performance by diversity. Diversity links or diversity receivers are commonly used which are either spatially separated (typically on the same tower) or otherwise with links have different parameters such as frequency or polarization. The attenuation levels of diversity receivers may be individually processed according to methods of the present invention. Alternatively, the attenuation levels may be pre-processed using a simple average or by using a special model relating attenuation to atmospheric phenomena the model being based on the details and type of diversity in use. In either case, the presence of diversity receivers provides a redundancy which reduces the overall error of the mapping.

It is another intention of the present invention to provide for “separation” of the different atmospheric phenomena such as providing a separate real time mapping of fog and precipitation in the monitored region.

It should be noted that while the discussion herein is applied to providing maps rainfall rate in a geographic area, the principles of the present invention may be adapted for use in, and provide benefit for mapping in real time other atmospheric phenomena such as visibility, air quality, humidity or fog.

While the discussion herein is directed by way of example to the use of previously existing cellular backhaul microwave links, the principles of the present invention may be readily adapted for use with other previously existing fixed point to point radio links or optical wireless links and even mobile links especially when the location of the endpoints may be determined, e.g. using a global positioning system (GPS). Further, although the present discussion relates to line-of-sight links, line-of-sight is not a necessary requirement and teachings of the present invention may be applied as well to non line-of-sight communications links such as radio links at low frequency, e.g. 2.5 Ghz.

It should be further noted that the principles of the present invention are applicable to real time meteorological and hydrological monitoring and prediction. Teachings of the present invention may be applied to provide real time reporting of atmospheric conditions as a public service such as for travelers or traffic reporting

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

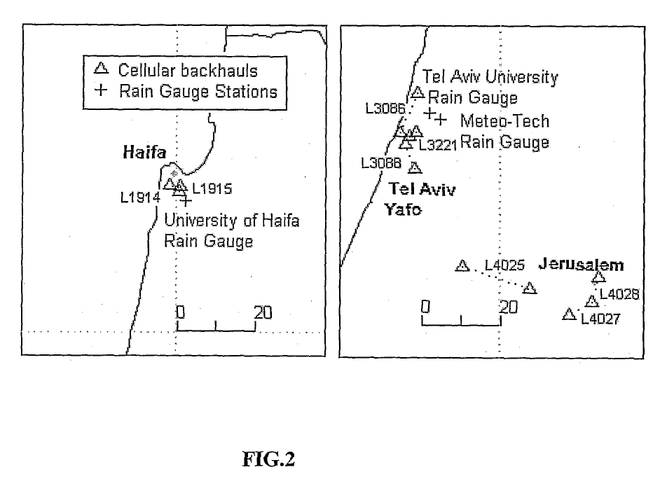

Referring now to the drawings, FIG. 2 illustrates locations of cellular backhaul links, used for rainfall estimation for the feasibility study, according to embodiments of the present invention, and rain gauge stations, used for comparison, in northern and central Israel. The identification of links including frequency and length) are given in Table 1 below.

TABLE 1
Characteristics of cellular backhaul links used.

| | Frequency | |
|---|---|---|
| Link ID | band, GHz | Length, km |
| L1914 | 18 | 2.59 |
| L1915 | 23 | 1.15 |
| L3086 | 18 | 9.48 |
| L3088 | 18 | 5.88 |
| L3221 | 23 | 1.53 |
| L4025 | 8 | 16.11 |
| L4027 | 18 | 5.77 |
| L4028 | 18 | 5.86 |

Simultaneous observations of large amount of radio links in a monitored area allow creation of instantaneous rainfall rate maps, reflecting a rainfall rate distribution near the surface. A two step approach is used. Given known parameters of each link including frequency, polarization, and optionally other available parameters such as temperature or humidity, a power law empirical model is preferably used to estimate the rainfall rate R₁ in mm/hour averaged over the link.

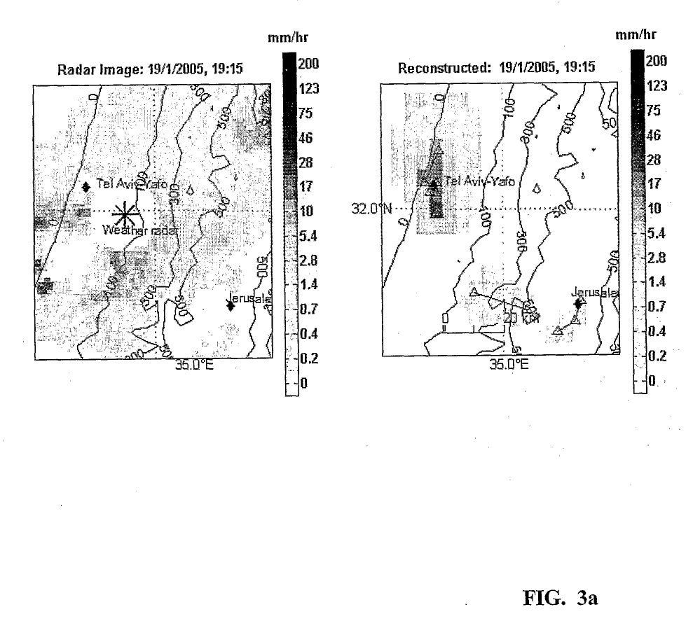

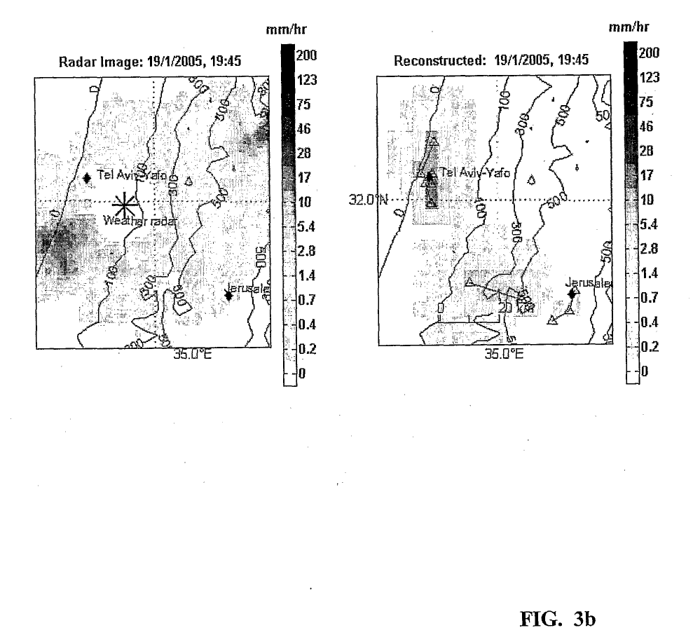

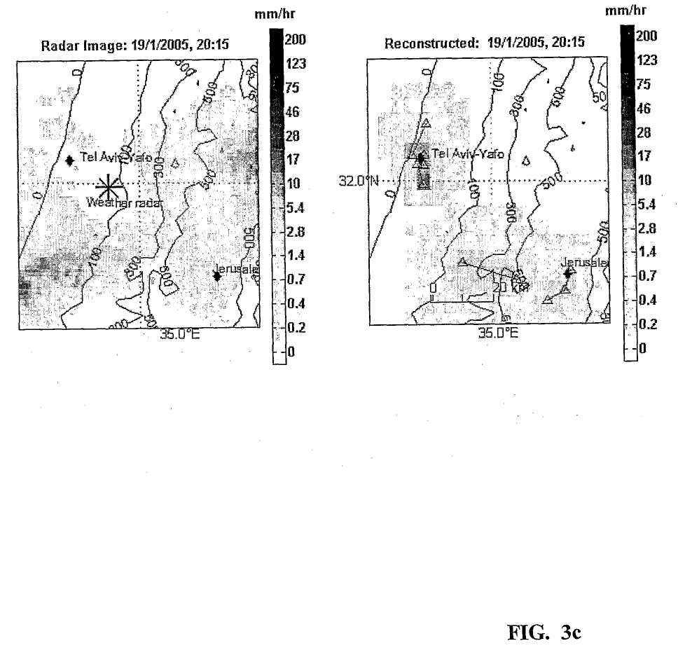

A non-linear tomographic reconstruction algorithm, according to an embodiment of the present invention, and described below is used in order to estimate the spatial rainfall rate distribution FIGS. 3a,3b, and 3c show time slices of dynamic rainfall rate maps, as generated according to the non-linear tomographic reconstruction (right), compared to the weather radar images, in different regions. FIGS. 3a-c illustrate a comparison of rainfall rate based on cellular backhaul attenuation (right), to weather radar images (left), over central Israel, Jan. 19, 2005. An important advantage of rainfall rate estimates using cellular backhaul links can be seen on FIGS. 3a-3c, cellular backhaul links show rainfall attenuation near the surface when there is already clear sky on weather radar images, providing, therefore, more accurate near-the-surface rainfall rate estimates.

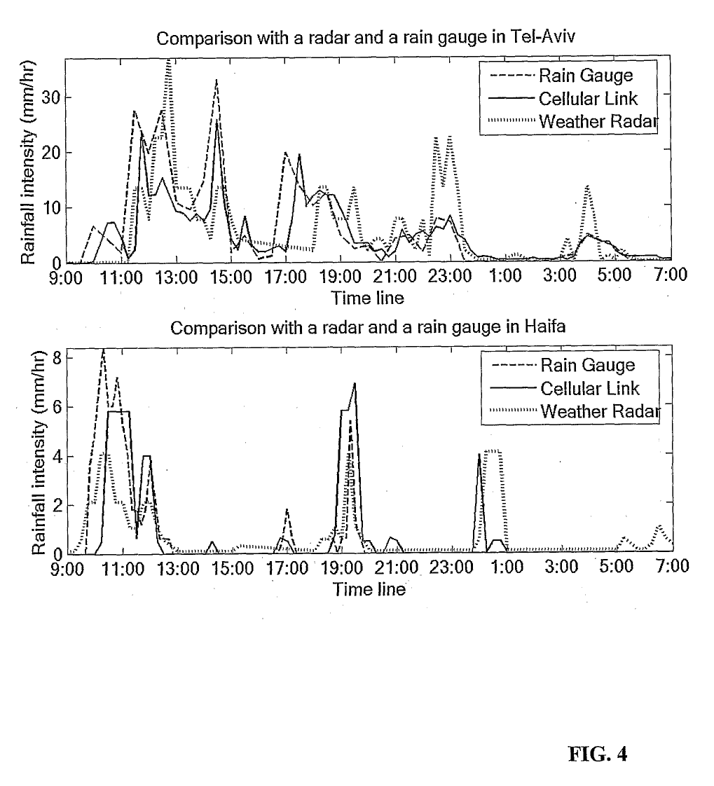

FIG. 4 is a graph comparing in time rainfall intensity measured by cellular links, rain gauges, and a weather radar, in two areas in Israel: (A) Tel-Aviv and (B) Haifa. The rainfall event was observed on 19 to 20 Jan. 2005. The rain gauges work at temporal resolutions of 30 min (A) and 10 min (B), whereas the wireless links provide measurements every 15 min. Temporal lags between the cellular data and the rain gauges are partly due to differences in locations of the links and the rain gauges (they are separated in space by about 2 km). Disparities, such as time lags, are also caused by the different nature of observations, i.e., line-integrated data in the cellular links versus point measurements in the rain gauges. Estimates of rainfall rate based on cellular backhaul links reflect rain-gauge observations much better than radar. Correlation with rain gauges is 0.86 for a 15-min-interval rain intensity and 0.9 for an hourly interval, versus 0.81 and 0.85, respectively, for radar, when evaluated from the maximal value over a 3×7 km² area. However, the corresponding correlation values from the literature at 3-km gauge-separation distance with radar are 0.59 and 0.71, respectively. The estimates are comparable although the rain gauge stations and backhaul links are at close but still different locations, with 2-3 km. and also the measurements of rainfall rate are based on cellular backhaul links that are integrated over the path of the link.

### A. Linearization for the Tomography Problem for Atmospheric Monitoring Using Network of Wireless Sinks

### 1 Formulation

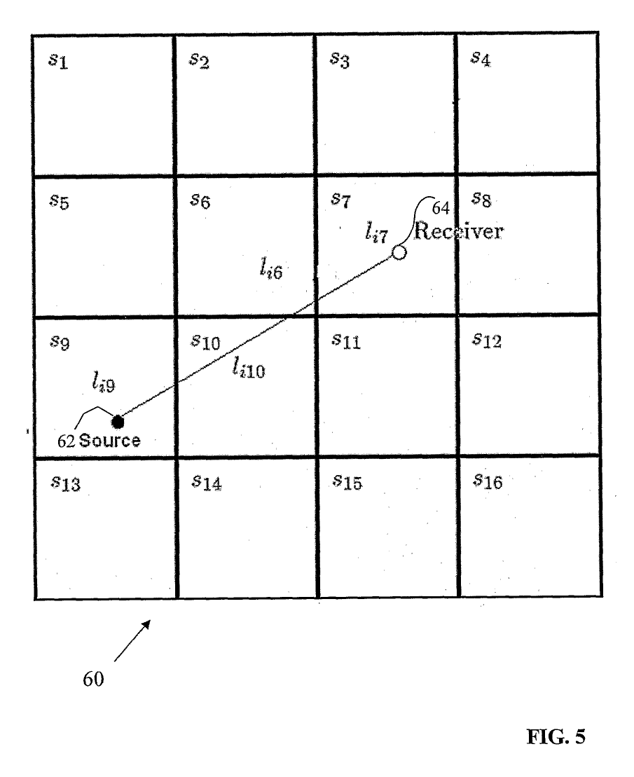

FIG. 5 illustrates schematically the tomography problem for mapping of rainfall intensities in a geographic area or region 60. Geographic region 60 is subdivided, for purposes of illustration into square cells sⱼ of equal size, however, in some embodiments of the present invention, it is advantageous to optimally divide area 60 into cells of others sizes, shapes or differing size/shape according to geographic criteria and/or availability of link attenuation information. A single radio link is shown with transmitter or source 62 and receiver 64 including a portion l₁₉ within cell s₉, a portion lᵢ₁₀ in cell s₁₀, a portion lᵢ₆ in cell s₁₆ and a portion lᵢ₇ in cell s₁₇.

The tomography problem is formulated according to the rainfall attenuation formula:

$$\begin{matrix}{A}_{i} = {d}_{i} {a}_{i} {R}_{i}^{{b}_{i}} = {\sum }_{j = 0}^{M - 1} {l}_{ij} \cdot {a}_{i} {R}_{i}^{{b}_{i}} = {a}_{i} {\sum }_{j = 0}^{M - 1} {{l}_{ij} ( {r}_{j} )}^{{b}_{i}} , & ( A1 ) \\ {d}_{l} = {\sum }_{j = 0}^{M - 1} {l}_{ij} , where & ( A2 )\end{matrix}$$

Aᵢ=propagation attenuation in link i.
i=0 . . . N−1—wireless links,
j=0 . . . M−1—cells sⱼ where the reconstruction is performed.
Rᵢ—average rainfall observed by a link i.
rⱼ—reconstructed rainfall in a cell j.
dᵢ—the length of the link i.
lᵢⱼ—the length of the segment of the link i over the cell j.
a,b—attenuation conversion constants.

The tomographic equation is therefore formulated as:

$${\sum }_{j = 0}^{M - 1} {{l}_{ij} ( {r}_{j} )}^{{b}_{i}} = {R}_{i}^{{b}_{i}} {\sum }_{j = 0}^{M - 1} {l}_{ij} \qquad ( A3 )$$

This equation is non-linear and can be solved using different embodiments of the present invention. The solution proposed here is an iterative algorithm, where the problem is linearized at every iteration and is solved by a standard method for linear equations. A smoothness constraint, e.g. neighbor correlation, and a feasibility constrant, e.g. non-negativeness are typically applied at every iteration.

### 2 Linearization

The proposed iterative algorithm is based on consecutive refinement of the solution, where linear inversion is performed at every iteration.

The linearization is done using the Newton method, by means of taking the two first terms of the Taylor series expansion of a non-linear member (rⱼ)^{b}^{ᵢ} at the iteration t in the vicinity of the (t−1)th solution:

rⱼ(t)^{b}^{ᵢ}≈rⱼ(t−1)+^{b}^{ᵢ}+bᵢr·ⱼ(t−1)^{b}^{ᵢ}⁻¹(rⱼ(t)−rⱼ(t−1)) (A4)

where rⱼ(t) is a rainfall estimate for a cell j at the iteration t, and rⱼ(t−1) is the previous estimate at the iteration t−1.

Rewrite (4):

rⱼ(t)^{b}^{ᵢ}≈cᵢⱼ(t)rⱼ(t)+gᵢⱼ(t), (A5)

where the coefficients cᵢⱼ(t) and gᵢⱼ(t) are:

cᵢⱼ(t)=bᵢrⱼ(t−1)^{b}^{ᵢ}⁻¹

gᵢⱼ(t)=rⱼ(t−1)^{b}^{ᵢ}−cᵢⱼ(t)rⱼ(t−1) (A6)

Then rewrite (3) in a linearized form:

$${\sum }_{j = 0}^{M - 1} {c}_{ij} ( t ) {l}_{ij} {r}_{ij} ( t ) = {R}_{i}^{{b}_{i}} {\sum }_{j = 0}^{M - 1} {l}_{ij} - {\sum }_{j = 0}^{M - 1} {l}_{ij} {g}_{ij} ( t ) \qquad ( A7 )$$

Or, in the matrix form:

\hat{M}(t)·r(t)=b(t), (A8)

Where

$$\begin{matrix}\hat{M} ( t ) = {\hat{m}}_{ij} = [ \begin{matrix}{c}_{00} ( t ) {l}_{00} & {c}_{01} ( t ) {l}_{01} & … & … \\ … & … & … & … \\ {c}_{N - 10} ( t ) {l}_{N - 10} & … & … & {c}_{N - 1 M - 1} ( t ) {l}_{N - 1 M - 1}\end{matrix} ] , & ( A 9 ) \\ b ( t ) = [ \begin{matrix}{\sum }_{j = 0}^{M - 1} {l}_{0 j} ( {R}_{0} - {g}_{0 j} ( t ) ) \\ … \\ {\sum }_{j = 0}^{M - 1} {l}_{N - 1 j} ( {R}_{N - 1} - {g}_{N - 1 j} ( t ) )\end{matrix} ] , & ( A 10 ) \\ r ( t ) = [ \begin{matrix}{r}_{0} ( t ) \\ … \\ {r}_{M - 1} ( t )\end{matrix} ] . & ( A 11 )\end{matrix}$$

The linearized equation can be solved by standard inversion methods (e.g. SIRT).

### 3 Algorithm

The iterative algorithm may be implemented in two ways:
1. Iteratively improve the linearized estimates, employing full matrix inversion at every step.
2. Embed the linearization directly into an iterative inversion algorithm.

Notice that for the stability of the inversion for the values of b less than 1, it is necessary to add a small constant to the zero estimates between iterations.

For this feasibility study, the SIRT (Simultaneous Iterative Reconstruction Technique) algorithm is used. However, any other linear inversion technique (e.g. ART—Algebraic Reconstruction Technique, or SVD pseudo-inversion) are applicable for the “iterative linearization” part.

### 3.1 Iterative Linearization

The algorithm is formulated as following:
1. Initialization:
   a. t=0
   b. Estimate the initial vector r(0) by any approximate method (e.g. my means of selection of the closest available average link data observation or Inverse Distance Interpolation).
2. t=t+1
3. Calculate \hat{M}(t), b(t) using formula (9), (10).
4. Estimate r(t) from the equation (8) by using, for example, the SIRT inversion method.
5. Stop iterations if ∥r(t)−r(t−1)∥<ε or if t>T, where ε, T are predefined thresholds.
6. Return to the step 2.

### 3.2 Embedded Linearization

The algorithm is essentially the same as the “Iterative Linearization”, except at the step “4” instead of solution of the equation (8), one SIRT iteration is calculated:

$${r}_{i} ( t ) = {r}_{i} ( t - 1 ) + \frac{1}{M} {\sum }_{k = 1}^{M - 1} \frac{( {b}_{i} ( t ) - {\sum }_{j = 1}^{M - 1} {l}_{ij} {r}_{j} ( t - 1 ) ) \cdot {\hat{m}}_{ik} ( t )}{{{m}_{ik} ( t )}^{2}} \qquad ( A12 )$$

### 4 Results

Simulations were performed in order to estimate the performance of the above method. Following statistics were used:
1. Maximum 2D correlation coefficient between the original and the reconstructed model
2. Root mean square (RMS) error
3. RMS error, normalized by average rainfall intensity
4. Absolute integral error over the 100 reconstructed cells
5. Absolute integral error, normalized by the average rainfall.

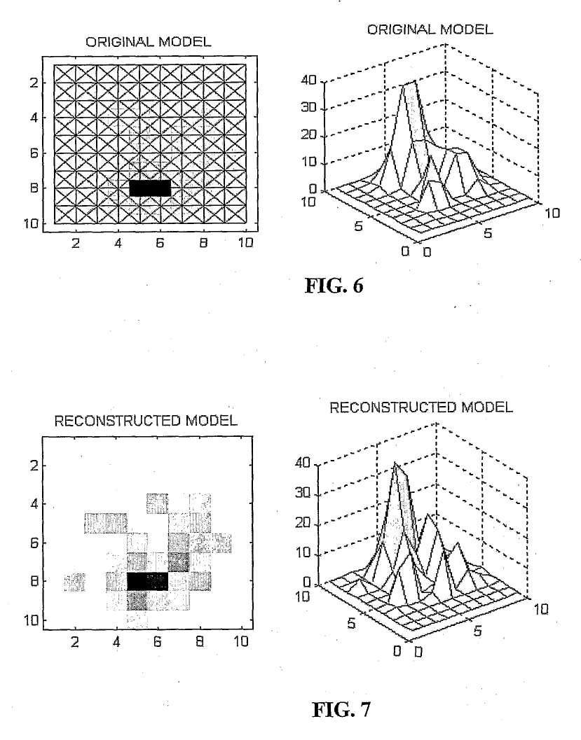

For the simulations, 100 cells and 54 links are used. The original simulated configuration of rainfall rate over the 100 cells is illustrated in FIG. 6. At typical rainfall intensities, the b parameter varies 0.7-1.3, so for the purpose of a preliminary simulation the same b parameter is used for all 54 links in this range. The simulation results shown in FIG. 7 illustrate the feasibility of the method using “b” as random, uniformly distributed in the range 0.1-2.0 across links.

TABLE 2
Simulation results

| The “b” | | |
|---|---|---|
| parameter | | Non-Linear (linearized) |
| from | Linear Reconstruction in | Reconstruction |
| equation (1) | assumption of “b” = 1 | accounting for actual “b” |
| 1 | Corr. Coef: 0.97 | |
| | RMS error: 0.01 | |
| | RMS error norm: 0.00 | |
| | Integral error: −1.97 | |
| | Integral error norm: −0.01 | |
| 0.7 | Corr. Coef: 0.97 | Corr. Coef: 0.96 |
| | RMS error: 8.94 | RMS error: 0.91 |
| | RMS error norm: 2.94 | RMS error norm: 0.30 |
| | Integral error: 74.42 | Integral error: 6.88 |
| | Integral error norm: 0.24 | Integral error norm: 0.02 |
| 1.3 | Corr. Coef: 0.97 | Corr. Coef: 0.98 |
| | RMS error: 6.49 | RMS error: 0.13 |
| | RMS norm: 2.13 | RMS error norm: 0.04 |
| | Integral error: −68.23 | Integral error: −4.89 |
| | Integral error norm: −0.22 | Integral error norm: −0.02 |
| Random, | Corr. Coef: 0.87 | Corr. Coef: 0.94 |
| uniformly | RMS: −8.63 | RMS error: −0.38 |
| distributed | RMS normalized: −2.84 | RMS normalized: −0.12 |
| 0.1-2.0 | Integral error: −26.12 | Integral error: −1.27 |
| across links | Integral normalized: −0.09 | Integral normalized: 0.00 |

### B. Probabilistic Reconstruction

An alternative approaching for mapping precipitation intensity, according to an embodiment of the present invention is probabilistic reconstruction. \hat{R}(x,y) is precipitation estimate at coordinates (x,y), R₁ is precipitation amount observed by link lεL, and the value P(R(x,y)|xₗ,yₗ,R₁) is the probability that the true precipitation intensity in (x,y) is R₁, accounting for the inherent spatial properties of precipitation:

$$\hat{R} ( x , y ) = \frac{{\sum }_{l ∈ L} P ( R ( x , y ) \vert {x}_{l} , {y}_{l} , {R}_{l} ) \cdot {R}_{l}}{{\sum }_{l ∈ L} P ( R ( x , y ) \vert {x}_{l} , {y}_{l} , {R}_{l} )}$$

### C. Reconstruction of Rainfall Rate Based on Inverse Distance Interpolation

### Background on Shepard's Interpolation Method:

Let (x₁,y₁,f₁), (x₂,y₂,f₂), . . . , (x_{N},y_{N},f_{N}) be the set of given N data points, where the fᵢ-values are samples of some function f₁(x,y) that is non-negative for xε[x₁,x_{N}] and yε[y₁,y_{N}]. The simplest form of inverse distance weighted interpolation is commonly called “Shepard's method”⁴ and is given by:

$$F ( x , y ) = \frac{{\sum }_{i = 1}^{N} {W}_{i} ( x , y ) \times {f}_{i}}{{\sum }_{i = 1}^{N} {W}_{i} ( x , y )} \qquad Eq . ( C1 )$$

Where Wᵢ(x,y) is the weight functions assigned to each data point.

The classical form of the weight function is:

$${W}_{i} ( x , y ) = \frac{1}{{( x - {x}_{i} )}^{2} + {( y - {y}_{i} )}^{2}} ,$$

when using it the method is called inverse distance weighted interpolation method, the method is based on the assumption that the interpolating surface should be influenced most by the nearby points and less by the more distant points. The interpolating surface is a weighted average of the scatter points and the weight assigned to each scatter point diminishes as the distance from the interpolation point to the scatter point increases. 4. Shepard D.: A two-dimensional interpolation function for irregularly spaced data. In Proceedings of 23_{rd} National Conference (New York, 1968), ACM, PP 517-523.

The Shepard interpolation method has been extensively researched for various applications and has various forms and advanced additions which may be applied in different embodiments of the present invention.

Estimating Spatial Rainfall Intensities from Scattered Data Points

Specifically, for estimating the rainfall intensity at location (x,y) out of spatially scattered rainfall intensities data points, weights are calculated using a search radius and the weighting function for Eq. C1 is given by

$${W}_{i} ( x , y ) = \frac{{( 1 - \frac{{d}_{i}}{R} )}^{2}}{{( \frac{{d}_{i}}{R} )}^{2}} For \frac{{d}_{i}}{R} \leq 1$$

$$And$$

$${W}_{i} ( x , y ) = 0 For \frac{{d}_{i}}{R} \geq 1$$

Where dᵢ is the distance between location (x,y) and data point i and. The choice of R depends on the density of the data points and should be chosen so that the sampling circle includes at least five sample points Let θ be the required estimation for rain rate at location (lat,long) and by yᵢε[y₁,y_{N}] the rain rate values at data point i. In this case we can write

$$θ = \frac{{\sum }_{i = 1}^{N} {W}_{i} \times {y}_{i}}{{\sum }_{i = 1}^{N} {W}_{i}}$$

Or in a vector manner—θ=h^{T}×Y

Where

$$\underline{h} = ( \begin{matrix}\frac{{W}_{1}}{{\sum }_{i = 1}^{N} {W}_{i}} \\ \frac{{W}_{2}}{{\sum }_{i = 1}^{N} {W}_{i}} \\ ⋮ \\ \frac{{W}_{N}}{{\sum }_{i = 1}^{N} {W}_{i}}\end{matrix} ) and \underline{Y} = ( \begin{matrix}{y}_{1} \\ {y}_{2} \\ ⋮ \\ {y}_{N}\end{matrix} )$$

### Interpolation Using Fixed Terrestrial Point-To-Point Line of Sight Microwave Links—

### Let:

(Lat₁₁,Long₁₁,Lat₁₂,Long₁₂,A₁), (Lat₂₁,Long₂₁,Lat₂₂, Long₂₂,A₂), . . . , (Lat_{N1},Long_{N1},Lat_{N2},Long_{N2},A_{N})
be the set of given N microwave links, each link is spatially represented by the coordinates of its two edges—(Latᵢᵢ₁,Longᵢ₁,Latᵢ₂,Longᵢ₂) and by Aᵢ values which are samples of the integrated attenuation along the link ([dB]) induced by rain. The rain induced attenuation on a line-of-sight (LOS) path has been extensively studied and the most basic and commonly used relation is expressed as A(dB)=aR^{b} L where R[mm/h] in the rain rate along the link, L[km] is the link length and a and b are mainly a functions of frequency f but also of rain temperature t and drop size distribution. The validity of the method is now fairly well established, though the relation is regarded as empirical, a strong theoretical justification exists for this choice. The links attenuation values Aᵢ are converted to rain rate by

$$R [ mm / h ] = {( \frac{A}{aL} )}^{\frac{1}{b}}$$

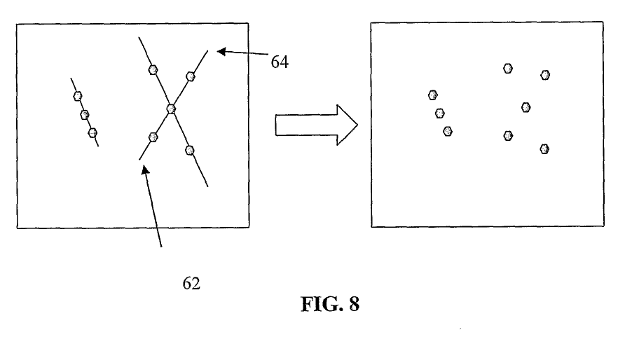

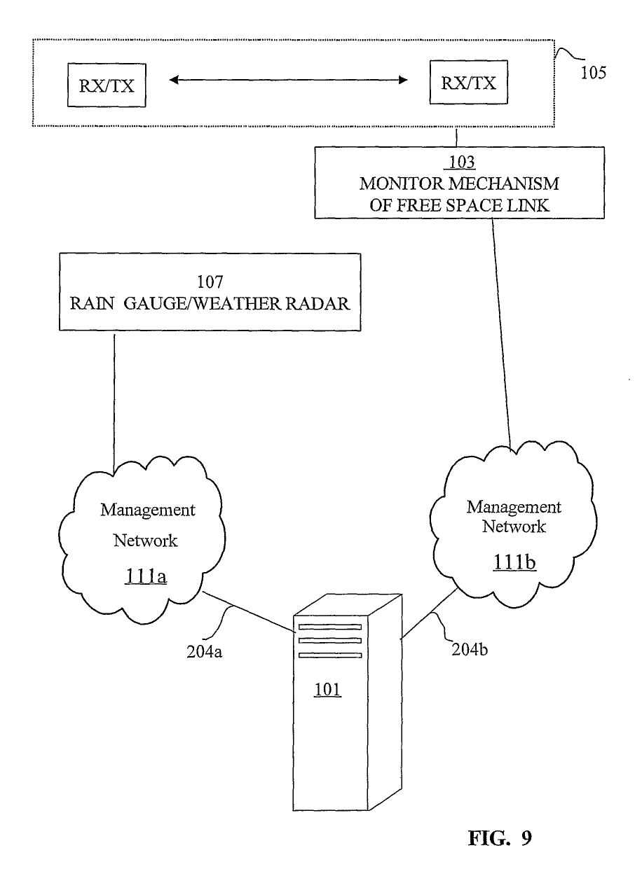

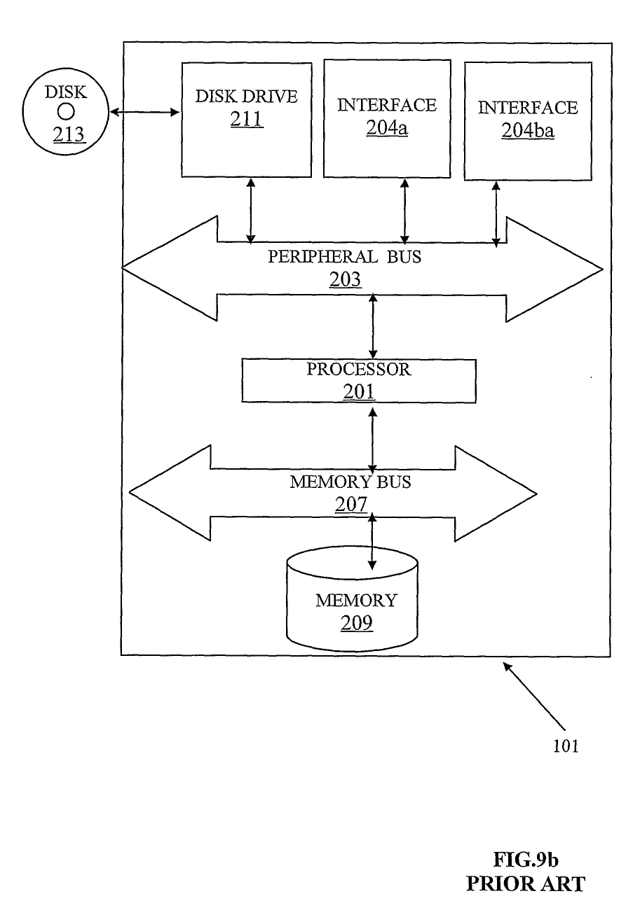

Reference is now made to FIG. 8 which illustrates three links in a geographic area 60 and a method for converting the links into data points, according to an embodiment of the present invention. For one of links endpoints (transceivers) 62 and 64 are shown. Each link is represented spatially by a number (e.g. three), of equally spaced, data points

(Latᵢ₁,Longᵢ₁,Latᵢ₂,Longᵢ₂,A₁) [symbol] (xᵢ₁,yᵢ₁,Rᵢ), (xᵢ₂,yᵢ₂,Rᵢ), (xᵢ₃,yᵢ₃,Rᵢ)

### Quantization Error

A constraint of 1 dB attenuation sample resolution is presented by the system (see section on the system) this causes an inherent quantization error, when converted into rain rate the quantization error depends on the link length—

For example—

For a 1 km link length 1 dB attenuation is converted to a rain rate of

$${R}_{i} [ mm / h ] = {( \frac{{A}_{i}}{{aL}_{i}} )}^{\frac{1}{b}} = {( \frac{1}{a} )}^{\frac{1}{b}} \approx 8 [ mm / h ]$$

Were as for a 5 km link length 1 dB attenuation produce a rain rate of

$${R}_{j} [ mm / h ] = {( \frac{{A}_{j}}{{aL}_{j}} )}^{\frac{1}{b}} = {( \frac{1}{5 a} )}^{\frac{1}{b}} \approx 1.8 [ mm / h ]$$

As one can see the quantization error is strongly related to the link length and can be described in the following stochastic manner—

$${n}_{i} ∼ U ( - \frac{1}{2} {( \frac{{A}_{i}}{{aL}_{i}} )}^{\frac{1}{b}} , \frac{1}{2} {( \frac{{A}_{i}}{{aL}_{i}} )}^{\frac{1}{b}} )$$

### Proposed Novel Model for Spatial Rain Rate Interpolation and Parametric Estimation Solution

Let θ denote the required rain rate at location (lat,long) and [y₁,y_{N}] the sampled rain rate data point's values at different locations. The proposed novel model for rain rate is based on the inverse weighted interpolation method and is given by:

θ≈h^{T}×(Y−n) Eq. C5

Where

$$\underline{h} = ( \begin{matrix}\frac{{W}_{1}}{{\sum }_{i = 1}^{N} {W}_{i}} \\ \frac{{W}_{2}}{{\sum }_{i = 1}^{N} {W}_{i}} \\ ⋮ \\ \frac{{W}_{N}}{{\sum }_{i = 1}^{N} {W}_{i}}\end{matrix} )$$

is build out of the relative distance between θ and the data points,

$$\underline{Y} = ( \begin{matrix}{y}_{1} \\ {y}_{2} \\ ⋮ \\ {y}_{N}\end{matrix} )$$

is the calculated rain rate value in each data points, The error vector

$$\underline{n} = ( \begin{matrix}{n}_{1} \\ {n}_{2} \\ ⋮ \\ {n}_{N}\end{matrix} )$$

is the additive error accompanies the data points.

It is apparent that by assigning n=0 we would get the inverse weighted interpolation method as previously described.

Rain gauge's rain rate values can be integrated into the model with zero error (nᵢ=0), and data point yⱼ from a microwave link can be integrated to the model with appropriate stochastic error: nⱼ.

Let us multiply each side of Eq. C5 by h:

hθ=hh^{T}×(Y+n) so we can get—

Y=(hh^{T})⁻¹hθ+n

Denote G≡(hh^{T})⁻¹h

If the error vector consists only of un-correlated quantization errors then we can write

$$W ≡ COV ( \underline{n} ) = ( \begin{matrix}var ( {n}_{1} ) & 0 & 0 \\ 0 & var ( {n}_{1} ) & \\ & & var ( {n}_{N} )\end{matrix} )$$

And the weighted least square (WLS) solution for the above equation would be

θ_{WLS}=(G^{T}W⁻¹G)⁻¹G^{T}W⁻¹=(((hh^{T})⁻¹h)^{T}W⁻¹((hh^{T})⁻¹h))⁻¹((hh^{T})⁻¹h)^{T}W⁻¹Y

According to the embodiments of the present invention, the concept of variance of rainfall estimation due to quantization error, e.g. based on link length, is introduced into the reconstruction calculation. Additive errors other than quantization error may be treated similarly and each observation, e.g attenuation value, from a link with known variance, contributes into an overall estimation in relation to the variance of the link. This concept is applicable not only inverse distance interpolation, but to any other reconstruction algorithm as well (e.g. tomographic reconstruction)

### D. Separation of Atmospheric Phenomena

In the previous sections, the teachings of the present invention are applied to a single atmospheric phenomenon, rainfall rate or intensity. In some cases, when a sufficient number and variety of free-space communications links are available, the teachings of the present invention may be applied to separate and map in real time different atmospheric phenomenon, e.g. rainfall rate and fog. As a simple example, the same monitored area includes a network of cellular backhaul microwave links and another network of infrared wireless optical links of electromagnetic wavelength (0.8-1.5 micrometers. It is well known that infrared wireless links due to the shorter wavelength is more strongly attenuated by fog than the cellular backhaul microwave links. A tomographic problem is formulated separately for each of the infrared and microwave links, according to the teachings herein. Each problem is linked with for instance a linear correction factor for the attenuation based on the other problem. The two problems may be solved simultaneously to generate both real time mappings of fog and rainfall intensity.

In some cases, a technique known as “blind signal separation” may be used. In the context of “blind signal/source separation” respective attenuation attributed to different atmospheric phenomena are different “signals”. The principles of “Blind Signal Separation” (BSS) are described in: “Blind signal separation: Statistical Principles”, Jean-Francois Cardoso (Proceedings of the IEEE, vol 9 no. 10 pp. 2009-2026 October 1998) included herein by reference for all purposes as if entirely set forth herein. Blind signal separation (BSS) is used to recover signals or sources from several observed mixtures of the signals Typically the observations are obtained at the output of a set of sensors, e.g. received signal level monitors, each sensor receiving a different combination of the source signals The term “blind” stresses the fact that the source signals are not observed independently and no a priori information is available about the mixture of signals. The lack of a priori knowledge about the mixture is compensated by a statistically strong but often physically plausible assumption of statistical independence between the source signals.

Reference is now made to FIG. 8 which illustrates an embodiment of the present invention. A free-space communications link 105 is shown. Although only one link 105 is shown, the one link 105 shown represents multiple links 105i=0 . . . N−1 distributed throughout geographic region 60. A monitoring mechanism 103 is shown which monitors received signal or attenuation levels. Monitoring mechanism 103 is generally integrated with communications link 105, and is well known in the art. Typically, a transmitted signal level, in dbmW, is measured (or otherwise known a priori) at the transmitter end of communications link 105 and a received signal level in dbmW is measured at the receiver at the other end of link 105. The difference is the attenuation level of the link measured in decibels (dB). The attenuation levels or equivalently the transmitted and received signal levels are input to computer 101 over a management network 111b through interface 204b. The attenuation levels are either computed in computer 101, by a computer within management network 111b or by a processor attached to monitor mechanism 101. In some cases, statistical information related to attenuation levels is available from management network 111b and may be used for the simultaneous processing, for instance time intervals during which attenuation is at a maximum measurable level or minimum level. If other data is available such as rain gauge data or data from weather radar, these data may be provided to computer 101 typically using a second management network 111a through interface 204a for the simultaneous processing and mapping. Additional networks 111 (not shown) are preferably input each typically belonging to different operators of cellular backhaul networks, other telecommunications networks using free space communications including optical wireless infrared networks. Using computer 101 management information, e.g. link attenuation levels are processed and used to produce real time maps of atmospheric phenomena, e.g. rainfall intensity. The rainfall rate−related information may be transferred as a service over a data network to for instance travelers who are subscribers of a cellular telephone network.

Reference is now made to FIG. 8b, which illustrates a prior art computer 101, which performs the processing, according to embodiments of the present invention. Computer 101, includes a processor 201, a storage mechanism including a memory bus 207 to store information, (e.g. location of link endpoints, length of link, frequency (or wavelength), polarization and link modeling parameters, a and b) in memory 209 and a first and second interface 204 connecting to networks 111. Each interface 204 is operatively connected to processor 201 with a peripheral bus 203. Computer 101 further includes a data input mechanism 211, e.g. disk drive from a program storage device 213, e.g. optical disk. Data input mechanism 211 is operatively connected to processor 201 with a peripheral bus 203.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

While the invention has been described with respect to a limited number of embodiments, it will be appreciated that many variations, modifications and other applications of the invention may be made.

What is claimed is:

1. A method for mapping at least one atmospheric phenomenon in a geographic region, the method comprising the steps of:
(a) providing a plurality of previously existing free-space electromagnetic communications links distributed in the region;
(b) monitoring respectively attenuation levels by a plurality of monitoring mechanisms attached respectively to said previously existing free-space electromagnetic communications links; and
(c) simultaneously processing said attenuation levels, thereby mapping in the geographic region said at least one atmospheric phenomenon.

2. The method, according to claim 1, wherein said simultaneous processing includes applying at least one non-linear model relating said attenuation levels to said at least one atmospheric phenomenon, and solving a tomographic problem based on said at least one non-linear model and said attenuation levels.

3. The method, according to claim 2, wherein said solving said tomographic problem is performed by an iterative algorithm based on consecutive refinement and linear inversion at each iteration.

4. The method, according to claim 2, wherein said simultaneous processing includes an interpolation based on respective inverse distance from said previously existing free-space electromagnetic communications links.

5. The method, according to claim 4, wherein said interpolation is further based on respective lengths of said previously existing free-space electromagnetic communications links.

6. The method, according to claim 1, further comprising the steps of:
(d) subdividing said geographic region into a plurality of cells based on a spatial density of said free-space electromagnetic communications links in said cells; and
(e) calculating in said cells said at least one atmospheric phenomenon based on said attenuation levels.

7. The method, according to claim 1, wherein said at least one atmospheric phenomenon includes is selected from the group atmospheric phenomena consisting of precipitation, fog, dust, pollutants and water vapor.

8. The method, according to claim 1, wherein said at least one atmospheric phenomenon includes at least two independent atmospheric phenomena further comprising the step of:
(d) applying a blind signal separation technique, thereby separately mapping said at least two independent atmospheric phenomena.

9. The method, according to claim 1, wherein said mapping is performed at a point in said region by applying a probabilistic model based on respective proximity of said previously existing free-space electromagnetic communications links to said point.

10. A computerized system for mapping at least one atmospheric phenomenon in a geographic region, wherein a plurality of free-space electromagnetic communications links are previously distributed in the geographic region, the computerized system comprising:
(a) an interface to a plurality of monitoring mechanisms attached respectively to said free-space electromagnetic communications links, wherein said monitoring mechanisms respectively monitor a plurality of attenuation levels of said free-space electromagnetic communications links; and
(b) a processor which simultaneously processes said attenuation levels, and maps in the geographic region at least one atmospheric phenomenon.

11. The computerized system, according to claim 10, wherein said processor applies at least one non-linear model relating said attenuation levels to said at least one atmospheric phenomenon, and solves a tomographic problem based on said at least one non-linear model and said attenuation levels.

12. The computerized system, according to claim 11, wherein said tomographic problem is solved by performing an iterative algorithm based on consecutive refinement and linear inversion at each iteration.

13. The computerized system, according to claim 10, wherein said processor interpolates based on respective inverse distance from said free-space electromagnetic communications links.

14. The computerized system, according to claim 13, wherein said processor interpolates based on respective lengths of said free-space electromagnetic communications links.

15. The computerized system, according to claim 10, further comprising:
(c) a previously existing management system operatively connected to said monitoring mechanisms, wherein said previously existing management system transfers said received attenuation levels to said processor.

16. The computerized system, according to claim 10, further comprising:
(c) a previously existing meteorological measurement device situated in said geographic region, wherein a measurement of said previously existing meteorological measurement device is input to said processor for mapping said at least one atmospheric phenomenon.

17. The computerized system, according to claim 16, wherein said previously existing meteorological measurement device is selected from the group consisting of a rain gauge, a disdrometer and a weather radar.

18. The computerized system, according to claim 10, wherein at least two of the free-space electromagnetic communications links have a different operative parameter, wherein said operative parameter is selected from the group of wavelength and polarization.

19. The computerized system, according to claim 10, wherein at least one of said previously existing free-space electromagnetic communications links includes a plurality of diversity receivers, wherein multiple received diversity attenuation levels from said diversity receivers are input to said processor.

20. The computerized system, according to claim 10, wherein at least one of the free-space electromagnetic communications links includes a plurality of diversity receivers, wherein multiple received diversity signals from said diversity receivers are pre-processed based on the type of diversity.

21. The computerized system, according to claim 10, further comprising:
(c) a data interface which provides to a plurality of subscribers temporal information related to said at least one atmospheric phenomenon within at least one portion of said geographic region.

22. A program storage device readable by a computer, wherein the computer is operatively attached to a plurality of previously existing free-space electromagnetic communications links distributed in a geographic region, wherein attenuation levels are respectively monitored by a plurality of monitoring mechanisms attached respectively to said previously existing free-space electromagnetic communications links, the program storage device tangibly embodying a program of instructions executable by the computer to perform a method comprising the step of simultaneously processing said attenuation levels, thereby mapping in the geographic region said at least one atmospheric phenomenon.

23. The program storage device, according to claim 22, wherein said simultaneous processing includes applying at least one non-linear model relating said attenuation levels to said at least one atmospheric phenomenon, and solving a tomographic problem based on said at least one non-linear model and said attenuation levels.

24. The program storage device, according to claim 23, wherein said solving said tomographic problem is performed by an iterative algorithm based on consecutive refinement and linear inversion at each iteration.

25. The program storage device, according to claim 22, wherein said simultaneous processing includes an interpolation based on respective inverse distance from said previously existing free-space electromagnetic communications links.

26. The program storage device, according to claim 25, wherein said interpolation is further based on respective lengths of said previously existing free-space electromagnetic communications links.
